(19) United States
(12) Patent Application Publication
(10) Pub. No.: US 2026/0057365 A1
(43) Pub. Date: Feb. 26, 2026

(54) CONTACTLESS PAYMENT SYSTEM FOR HOSPITALITY SERVICES

(71) Applicant: GyftGram Corporation, New York, NY (US)

(72) Inventor: Kevin Michael Malley, New York, NY (US)

(21) Appl. No.: 19/106,390

(22) PCT Filed: Aug. 30, 2023
(86) PCT No.: PCT/US2023/073149

§ 371 Date: Feb. 25, 2025

Related U.S. Application Data
(60) Provisional application No. 63/402,566, filed on Aug. 31, 2022.

(51) Int. Cl. G06Q 20/32; G06Q 20/02; G06Q 20/20; G06Q 20/40

(52) U.S. Cl. CPC G06Q 20/3224; G06Q 20/027; G06Q 20/20; G06Q 20/40145

(57) ABSTRACT

System and methods for contactless payment for hospitality services are described. User and/or remote service provider computing systems in point-of-sale, electronic reservation book, payment gateway computer(s) action/events related to the hospitality service are handled in accordance with the user's physical location within a geofence-defined area and/or within proximity of an RF module. Request one or more biometric authentication methods based on received location data of the user's physical location in proximity to the geofenced area and/or RF module. After successful authentication, a user and/or remote service provider computing systems in point-of-sale, electronic reservation book, payment gateway computer(s) within a hospitality venue performs actions/events handled by operational states of the systems/methods, which provide venue specific contactless hospitality ordering and payment.

### CROSS-REFERENCE TO RELATED APPLICATION

This application is an International Application claiming priority to U.S. Provisional Patent Application No. 63/402,566, filed Aug. 31, 2022 which is incorporated by reference in its entirety herein.

### TECHNICAL FIELD

Systems and methods for contactless payment for hospitality services are described. User actions/events related to the hospitality service are handled in accordance with the user's physical location within a geofence-defined area and/or within proximity of an RF module. After one or more biometric authentication methods, a user within a hospitality venue performs actions/events handled by operational states of the systems/methods, which provide venue-specific contactless hospitality ordering and payment.

### BACKGROUND

More than half of all credit card fraud takes place within the hospitality industry leaving merchants responsible for accruing chargebacks and disputes. The result can be costly and damage the reputation of the service provider. The approaches described herein help eliminate fraud within the hospitality industry, in part, based on biometrically identifying a user prior to the remote service provider computing systems receiving hospitality instructions and/or requests from the system.

The present invention seeks to overcome the problems of fraud within the hospitality industry by providing a computing system that enables users(s) to request hospitality services through the use of computing devices after a user successfully performs one or more biometric authentication method(s). Hospitality service providers can also operate computing devices to communicate with the network service, and at times, to receive instructions to perform the hospitality services for requesting users(s). The network service can perform various operations to determine which hospitality service to assign to which requesting users(s) based on location data received from the computing devices operated by requesting users(s), and storing that data in a database and/or digital ledger (e.g., a blockchain database), respectively.

Existing approaches cannot provide for identifying a user through one or more biometric authentication method(s) prior to the system performing selective operations for a select point-of-sale (POS) computer, electronic reservation book (ERB) computer, and payment gateway computer based on location data provided by user devices.

Biometric spoofing attacks may be used to gain access to services, steal sensitive information, gain access to restricted areas, or even take control of a system. As malicious actors realize the potential for financial gain or other benefits from breaking into biometric systems, these attacks are becoming more common.

“Deepfakes” are highly realistic videos or images produced by deep learning and artificial intelligence that mimic someone's face, voice, and other biometrics, often with the intent of committing fraud or spreading misinformation. Deepfakes can be difficult to detect due to their high level of realism. Though some people make deepfake videos of popular actors for entertainment purposes, they can also be used to fool a liveness test (e.g., a technology used to detect and verify whether the captured biometric data such as facial images, fingerprints, or iris scans came from a live person or spoofed source).

If an attacker is able to create a fake ID photo followed by a deepfake presentation attack, they can create fake accounts on a range of platforms. These phony accounts can then be used to commit other fraud attacks with lesser risk of consequences.

Deepfakes pose a threat to liveness detection and facial recognition technology, but location and device intelligence represent one method for detecting deepfakes. Therefore, it is an advantage of the present invention to combine one or more biometric authentication methods with a user's real-time location data and prior location behavior, (e.g., movement of the user).

Another advantage to the present invention is one of the most formidable challenges in designing large-scale biometric systems is database and system security. In this context, security can be broadly defined as protection of information and information systems from unauthorized access, use, disclosure, disruption, modification, or destruction. In general, there are three major aspects of system security. Data confidentiality prevents illegitimate access or discloser of sensitive data or information. Integrity guards against improper modification or destruction of the system/data and ensures non-repudiation and authenticity of information. Availability guarantees timely and reliable access to and use of information.

Using a digital ledger (e.g., blockchain) to store transactional information provides the most essential benefit of making all the transactions more immutable. The data is stored as signed blocks, which link to each other, creating a chain of immutable interconnected data entries.

To sign a new block, a node needs to find an SHA-256 signature that matches specific criteria. To do so, it will use the nonce field to brute force possible solutions. Any new block needs to be validated with the majority of the validation nodes forming the blockchain. Once the block has been validated, it is added to all the nodes of the blockchain.

If any of the information in the data inside the block is altered, the signature becomes invalid. To make the block valid again, this signature would need to change. To ensure that the following blocks still work, a new signature would also need to be generated for each of them. Even if a node could regenerate those signatures, the changes would need to be accepted by a majority of the nodes hosting the blockchain.

For these reasons, blockchains are immutable. No information that is included in the data of the blocks can be changed. They are also managed by a set of decentralized nodes, removing the need for a central authority to control all the transactions.

Blockchain data storage improves the privacy and security of users(s)' data with its decentralized functioning. Therefore, it is an advantage of the present invention to offer an effective alternative to the traditional storage systems through a decentralized framework and/or integrate biometrics and distributed ledger technology where users(s) can be digitally authenticated through a single-token digital identity (e.g., digital ledger identifier) and/or system information can be stored in a digital ledger (e.g., a blockchain database).

Existing approaches also cannot provide for a computing system to automatically capture a payment amount after the respective user has traveled a fixed distance and/or exceeded a given time duration outside the virtual perimeter of the service provider, defined by geolocation/geofence and/or RF module, with a remaining balance for one or more unpaid items on an open tab or check.

Another advantage to the present invention is settlement of bills at the end of service can be time consuming and inconvenient for customers and hospitality service providers of restaurants or other entities. When a customer finishes a meal the need to interact with service staff at least two and often three times can increase customer wait time and slow down the ability for the hospitality service provider to seat additional parties to generate more merchant revenue. In addition, merchants that accept credit cards or debit cards typically will need to take the credit card or debit card out of consumer sight which can increase the possibility of running a fraudulent transaction. If the merchant uses a portable terminal to charge the consumers credit card or debit card the consumer could vacate the merchant premise before service staff returns leaving the hospitality service provider responsible for the incurred loss. In addition, the use of portable terminals is typically associated with extra costs for the merchant and contribute to further environmental resource depletion.

The systems of the present invention use three aspects which ideally work and interact concurrently: (i) one or more biometric authentication methods to identify user(s). (ii) based on location data from a mobile computing device in proximity to a geofence and/or RF module, (iii) wherein the data is stored in a database and/or digital ledger, (e.g. a blockchain database) for one or more remote service provider computing system(s) in point-of-sale (POS), electronic reservation book (ERB), and payment gateway computers and/or one or more mobile computing devices operated by user(s). These systems are particularly useful for managing hospitality services.

Therefore, it is an advantage of the present invention to provide systems and methods designed to eliminate these inefficiencies, giving the ability for consumers to leave a merchant premise without the need to wait for a check, scan a QR code, or interact with a merchant terminal. It is apparent from the foregoing there is a need for a contactless payment system that solves these problems and can be used across a wide range of different types of hospitality services. The present invention meets this need.

### SUMMARY

In examples described herein, a system can perform selective operations for a set of remote service provider computing system(s) based on the locations of mobile or computing devices operated by users(s). The system can detect or track the locations of mobile computing devices operated by users(s) to determine whether a location-based event has occurred with respect to any of the mobile computing devices. If a location-based event is detected in connection with a mobile computing device, the system can perform an operation(s) for the respective remote service provider computing system(s) that would otherwise not have been performed.

Provided for, among other embodiments, are the following.

A contactless payment system comprising:
a computing system comprising one or more processors for executing computer-readable instructions;
one or more databases and/or digital ledgers for storing the computer-readable instructions,
a plurality of computing devices, the plurality comprising one or more point-of-sale (POS) computer(s), one or more electronic reservation book (ERB) computer(s), and one or more payment gateway computer(s);
one or more networks interconnecting the computing system and the plurality of computing devices by one or more internet and/or local connections;
a user computing device in data communication with the computing system, the user computing device comprising an application (including internet browser interface) configured to:
   receive, from a user, user login credentials for the contactless payment system;
   select a venue providing the services;
   provide location data to the computing system; and
   perform one or more biometric authentication method(s);
a geofence located at the [hospitality venue] for defining a geofenced area for the service and/or an RF module located at the venue for defining a proximity to the service,
wherein the computing system determines whether a user computing device is within the geofenced area and/or in proximity to an RF module.

A contactless payment system, wherein the system is for hospitality services for a hospitality venue, comprising:
a computing system comprising one or more processors for executing computer-readable instructions;
one or more databases and/or digital ledgers for storing the computer-readable instructions,
a plurality of hospitality computing devices, the plurality comprising one or more point-of-sale (POS) computer(s), one or more electronic reservation book (ERB) computer(s), and one or more payment gateway computer(s);
one or more networks interconnecting the computing system and the plurality of hospitality computing devices by one or more internet and/or local connections;
a user computing device in data communication with the computing system, the user computing device comprising an application (including internet browser interface) configured to:
   receive, from a user, user login credentials for the contactless payment system;
   select a hospitality venue providing the hospitality services;
   provide location data to the computing system; and
   perform one or more biometric authentication method(s);
a geofence located at the hospitality venue for defining a geofenced area for the hospitality service and/or an RF module located at the hospitality venue for defining a proximity to the hospitality service,
wherein the computing system determines whether a user computing device is within the geofenced area and/or in proximity to an RF module.

A system wherein the data is stored in a database and/or digital ledger, (e.g., a blockchain database) and/or a plurality of guidelines for the computer system and/or plurality of hospitality computing devices.

A system wherein the computer system and/or plurality of hospitality computing devices are set to a first, default guideline when the user computer device is not within the geofenced area and/or is not in proximity to an RF module, and wherein the computer system and/or plurality of hospitality computing devices are set to a second, alternate guideline when the user computer device is within the geofenced area and/or is in proximity to an RF module.

A system wherein the data is stored in a database and/or digital ledger, (e.g., blockchain database) and/or a plurality of user states for the computer system and/or plurality of hospitality computing devices.

A system wherein the computing system and/or plurality of hospitality computing devices are set to a first user state when the user has selected a venue providing the hospitality services and has performed one or more biometric authentication method(s), and wherein the user computing device and/or computing system are set to a second user state when the user has not performed one or more biometric authentication method(s).

A system wherein the computer system does not allow for the hospitality service to be rendered to the user in the second user state (where the user has not performed the required biometric authentication).

A system of wherein the computer system and/or plurality of hospitality computing devices are set to one or more of a plurality of operational states, and wherein the operational states are selected or changed in accordance with events associated with the user computing device and/or plurality of hospitality computing devices.

A system of wherein the operational states are selected from
(i) an entry state, where the user computing device has entered the geofence or is in proximity with an RF module;
(ii) an order request state, where the user utilizes the user computing device to begin an order (optionally, by communication with the POS computer);
(iii) a pending item state, where the user has selected particular hospitality services to be rendered but has not yet placed an order;
(iv) an identified seating state, where the system and/or plurality of hospitality computing devices are updated with the seating location for the user;
(v) a payment authorization state, where the user has pre-authorized payment for the hospitality services to be rendered, but the transaction has not yet occurred (the payment authorization is optionally required before the hospitality services may be rendered);
(vi) a check request state, where the user is presented with the option to complete the transaction for the hospitality services rendered;
(vii) a payment capture state, where the user may initiate the transaction for any pre-authorized or non-previously authorized balances;
(viii) an unsuccessful payment capture state, where the initiated transaction failed;
(ix) a successful payment capture state, where the initiated transaction succeeded; and
(x) an exit state, e.g., where the user computing device has exited the geofence or is no longer in proximity with an RF module, wherein the exit state may initiate a payment capture state if the user did not pay for the rendered hospitality services prior to the exit state being set (if user leaves the venue without paying).

A method for contactless payment of hospitality services, comprising the steps of:
communicating, over one or more networks, with a
   plurality of computing devices of a plurality of
   point-of-sale (POS) computer(s), electronic reservation book (ERB) computer(s), and payment gateway computer(s) providing the hospitality service;
monitoring, in real-time, a location of each respective
   computing device of the plurality of computing
   devices based on location data received from a
   location monitor of the respective computing device;
determining whether to subject a respective point-of-sale (POS) computer,
   electronic reservation book (ERB) computer, and
   payment gateway computer to either (i) a default
   set of guidelines, or (ii) an alternative set of guidelines associated
   with a geofenced area and/or RF module, based on the location of
   the respective computing device relative to the
   geofenced area and/or RF module;
for each subjected point-of-sale (POS) computer,
   electronic reservation book (ERB) computer, and
   payment gateway computer of the plurality of
   point-of-sale (POS) computer(s), electronic reservation book (ERB)
   computer(s), and payment gateway computer(s) that is subject to
   the alternative set of guidelines, input an
   identifier of the subjected point-of-sale (POS) computer,
   electronic reservation book (ERB) computer, and
   payment gateway computer into a state, the identifier indicating
   an operational state to subject the point-of-sale (POS) computer,
   electronic reservation book (ERB) computer, and
   payment gateway from a plurality of states for the geofenced area/or RF module,
receiving, over the one or more networks, indication of a location-based event
   from a computing device of a first user(s), the location-based event
   indicating a user device has entered, exited, or performed some action
   within the geofenced and/or RF module area;
arranging the hospitality service for the first user(s)
   by (i) selecting the point-of-sale (POS) computer,
   electronic reservation book (ERB) computer, and
   payment gateway computer from one of the plurality of states
   and (ii) communicating, over the one or more networks, the set of instructions associated with the state to the selected point-of-sale (POS) computer,
   electronic reservation book (ERB) computer, and payment gateway computer;
receiving, over the one or more networks, a second
   hospitality request from a computing device of a
   second requesting user(s), the second hospitality request
   indicating a request external to the
   geofenced area and/or RF module; and
arranging the hospitality service for the second requesting
   user(s) by (i) selecting the point-of-sale (POS) computer(s),
   electronic reservation book (ERB) computer(s), and payment gateway computer(s) based at least in part on a proximity of the service provider geolocation of the second hospitality request, and (ii) communicating, over the one or more networks, the set of instructions associated with the state to the selected point-of-sale (POS) computer, electronic reservation book (ERB) computer, and payment gateway computer

A method wherein the executed set of instructions
further cause the computing system to:
for each respective user, generate a record indicating a number of instances in which the respective user(s) enter and/or exit the service provider geolocation to receive the hospitality service.

A method wherein the executed set of instructions further cause the computing system to:
for each respective user, generate a record indicating a duration of time a user(s) has remained at a seating location within the service provider geolocation.

A method wherein the executed set of instructions further cause the computing
system to:
determine the alternative set of guidelines by accessing a database and/or digital ledger (e.g., blockchain database) that stores information
corresponding to the geofenced area and/or RF module, the information including an identifier of a point-of-sale (POS) computer(s), electronic reservation book (ERB) computer(s), and payment gateway computer(s) associated with the geofenced area and/or RF module.

A method wherein the executed set of instructions further cause the computing system to:
monitor, in real time, an operational state of a user application executing on each of the plurality of computing devices of each respective user, the operational state indicating at least one of (i) whether the respective user has selected a service provider and performed one or more biometric authentication method(s) to receive the hospitality service, or (ii) whether the respective user has failed to perform a successful biometric authentication method(s) to receive the hospitality service.
A method wherein the executed set of instructions (in the alternative set of guidelines) further cause the computing system to:
monitor, in real time, an operational state of a point-of-sale (POS) computer(s), electronic reservation book (ERB) computer(s), and payment gateway computer(s), the operational state indicating at least one of (i) an entry state, e.g., after the respective user has entered a service provider geolocation associated with the geofence and/or RF module, based on the location data provided by the user device, request the point-of-sale (POS) computer to generate and/or display a touch-sensitive moveable (e.g., drag and drop) open check in a region on the GUI screen display associated with corresponding user information (e.g., a user identifier (ID) associated with the user, a digital ledger identifier (ID) associated with the user, a name, a photograph, a phone number, e-mail address, a device (ID) associated with user device, an application (ID) associated with the user application), request the point-of-sale (POS) computer to generate and display an illuminable touch-sensitive transfer check button configured as a selectable GUI widget in a region on the GUI screen display, request the electronic reservation book (ERB) computer to generate and/or display a moveable (e.g., drag and drop) reservation in a region on the GUI screen display associated with corresponding user information, request the electronic reservation book (ERB) computer to generate and/or display a moveable (e.g., drag and drop) wait list entry in a region on the GUI screen display associated with corresponding user information, (ii) an order request state, e.g., after the respective user has indicated via user input on the user application a request to start an order, request the point-of-sale (POS) computer to generate and display an identifier corresponding to an identifier associated with the moveable open check corresponding to the user in a region on the GUI screen display with a distinctive illumination treatment (e.g., highlight, flash, colored, etc.), (iii) a pending item state, e.g., after the respective user has indicated via user input on the user application one or more menu line item(s) (e.g., food, beverage, or other products or services) and/or after the respective administrative user has indicated via admin user input in the point-of-sale (POS) computer one or more menu line item(s) (e.g., food, beverage, or other products or services), request the point-of-sale (POS) computer to generate and display one or more menu line item(s) (e.g., food and beverage or other products or services) as moveable widgets (e.g., drag and drop) in a region on the moveable open check corresponding to the respective user that when selected activate one or more modifiers, (iv) an identified seating state, e.g., after the respective administrative user has moved a moveable reservation and/or wait list entry in the electronic reservation book (ERB) computer to a seating location on the GUI screen display and/or entered a location identifier (e.g., seat, table number) in the point-of-sale (POS) computer, request the point-of-sale (POS) computer to generate and display the corresponding location identifier (e.g., seat, table number) in a region on the moveable open check and/or automatically transfer the moveable open check to the seating location associated with the corresponding location identifier, (v) a payment authorization state, e.g., after the respective user has indicated via user input on the user application one or more menu line item(s) (e.g., food, beverage, or other products or services) and/or after the respective administrative user has indicated via admin user input in the point-of-sale (POS) computer one or more menu line item(s) (e.g., food, beverage, or other products or services) totaling a pre-determined authorization limit, request the payment gateway computer to authorize but not yet capture a payment amount, (vi) a check request state, e.g., after the respective user has indicated via user input on the user application a request for a check, request the point-of-sale (POS) computer to generate and display a notification and/or alert indicating a request to pay a check in a region on the moveable open check and/or request the point-of-sale (POS) computer to generate and display a touch-sensitive send payment button in a region on the moveable open check, (vii) a payment capture state, e.g., after the respective user has selected a pay button via user input on the user application request the payment gateway computer to capture the previously authorized amount and request to authorize and capture the difference between the final total ticket amount (e.g., tax, gratuity, and any other current charges) and previously authorized amount and/or request to authorize and capture the final total ticket amount (e.g., tax, gratuity, and any other current charges) upon detecting no prior authorization, (viii) an unsuccessful payment capture state, e.g., in response to an unsuccessful final total ticket amount payment capture in the payment gateway computer, request the point-of-sale (POS) computer to generate and display a notification and/or alert in a region on the moveable open check indicating an unsuccessful payment capture and/or request for an alternate or backup payment source (e.g., another credit card on file), (ix) a successful payment capture state, e.g., in response to a successful final total ticket amount payment capture in the payment gateway computer, request the point-of-sale (POS) computer to generate and display a notification and/or alert in a region on the moveable open check indicating a provisional electronic receipt, request the electronic reservation book (ERB) computer to generate and display a confirmed payment message for the seating location corresponding to the provisional electronic receipt in a region on the GUI screen display, (x) an exit state, e.g., after the respective user has traveled a fixed distance and/or exceeded a given time duration outside the virtual perimeter of the service provider geolocation and/or RF module with a remaining balance on a moveable open check, request the payment gateway computer to capture the previously authorized amount and request to authorize and capture the difference between the final total ticket amount (e.g., tax, gratuity, and any other current charges) and previously authorized amount and/or request to authorize and capture the final total ticket amount (e.g., tax, gratuity, and any other current charges) upon detecting no prior authorization, request the point-of-sale (POS) computer to generate and display a notification and/or alert in a region on the moveable open check indicating a balance due message, request the point-of-sale (POS) computer to generate and display a capture payment button in a region on the moveable open check, request the point-of-sale (POS) computer to generate and display a notification and/or alert in a region on the moveable open check indicating an unsuccessful payment capture and/or request for an alternate or backup payment source (e.g., another credit card on file) in response to an unsuccessful payment capture in the payment network gateway computer, request the point-of-sale (POS) computer to generate and display a notification and/or alert in a region on the moveable open check indicating a provisional electronic receipt in response to a successful payment capture, request the point-of-sale (POS) computer to automatically close a moveable open check associated with a provisional electronic receipt, request the electronic reservation book (ERB) computer to generate and display a confirmed payment message for the seating location corresponding to the provisional electronic receipt in a region on the GUI screen display in response to a successful payment capture, request the electronic reservation book (ERB) computer to automatically remove a reservation and/or waitlist entry associated with user information.

A method wherein the geofenced area and/or
RF module corresponds to hospitality services, which can be selected from a restaurant, hotel, shopping mall, cruise ship, airline, theatre, gaming venue, stadiums, resort, theme park, and concert venue.

A method wherein the geofenced area and/or
RF module corresponds to a point-of-sale (POS) computer,
electronic reservation book (ERB) computer, and
payment gateway computer.

A contactless payment system for hospitality services for a hospitality venue, comprising:
a computing system comprising one or more processors for executing computer-readable instructions;
one or more databases and/or digital ledgers (e.g., blockchain database) for storing the computer-readable instructions,
a plurality of hospitality computing devices;
one or more networks interconnecting the computing system and the plurality of hospitality computing devices by one or more internet and/or local connections;
a user computing device in data communication with the computing system:
a geofence for defining a geofenced area and/or an RF module located for defining a proximity,
wherein the computing system determines whether a user computing device is within the geofenced area and/or in proximity to an RF module.

A method for contactless payment utilizing a system

comprising:
a computing system comprising one or more processors for executing computer-readable instructions;
one or more databases and/or digital ledgers (e.g., blockchain database) for storing the computer-readable instructions,
a plurality of hospitality computing devices;
one or more networks interconnecting the computing system and the plurality of hospitality computing devices by one or more internet and/or local connections;
a user computing device in data communication with the computing system:
a geofence for defining a geofenced area and/or an RF module located for defining a proximity,
wherein the computing system determines whether a user computing device is within the geofenced area and/or in proximity to an RF module.

According to examples, the system described herein can be associated with, be in communication with, be a part of, or include a guest service arrangement system. A guest service arrangement system can arrange on-demand services to be provided by remote service provider computing system(s) for respective users(s) through use of mobile computing devices. In one example, the system can periodically receive location data (and/or other data) from individual mobile computing devices operated by users(s). Based on the received location data, the system can determine when a first mobile computing device has entered a service provider geolocation associated with a geofence and/or RF module. As described herein, a geofence can correspond to a geolocation and can be defined by a perimeter or at least three location data points. A location data point can correspond to an address, a landmark, or a geo-coordinate of a coordinate system, such as a latitude and a longitude. An RF module (e.g., radio-frequency module) can correspond to a geolocation and can be defined by a small electronic device used to transmit and/or receive radio signals between two devices. In an embedded system it is often desirable to communicate with another device wirelessly. This wireless communication may be accomplished through optical communication or through radio frequency (RF) communication. RF communications incorporate a transmitter and a receiver. RF modules may comply with a defined protocol of RF communications such as Zigbee, Bluetooth Low Energy, or Wi-Fi, or they may implement a proprietary protocol. When the system determines that the first mobile computing device has entered the service provider geolocation, the system can categorize the respective remote service provider computing system(s) as being subject to a set of guidelines different from the default guidelines that the respective remote service provider computing system(s) would have otherwise been subject to when the first mobile computing device is not within the service provider geolocation.

When the remote service provider computing system(s) is categorized as being subject to the set of guidelines, the system can perform operations for the remote service provider computing system(s) that are different from default operations associated with the default guidelines. Still further, the system can continue to periodically receive location data from the mobile computing devices, and based on the received location data, the system can determine when the first mobile computing device has exited the service provider geolocation. In response, the system can remove the categorization of the remote service provider computing systems as being subject to the set of guidelines. Once the categorization is removed, the system can perform default operations, if necessary, for the remote service provider computing systems.

In some examples, when a remote service provider computing systems is subject to an alternate set of guidelines different from the default guidelines, the system can process or manage the remote service provider computing systems differently from other remote service provider computing systems that are not subject to the alternate set of guidelines. For example, once the user enters a service provider geolocation, the remote service provider computing systems can be published to a channel with other remote service provider computing systems in the service provider geolocation. The system can perform an alternate selection process for those remote service provider computing systems in the channel as compared to a default selection process.

In other examples, each time a mobile computing device enters a service provider geolocation, the system can record information for each occurrence in a database and/or digital ledger (e.g., blockchain database). In one example, the system can use a counter to keep track of the number of times individual user(s) enter the service provider geolocation in a given duration of time (e.g., a day, a week, a month, etc.). Similarly, the system can keep track of the number of times individual user(s) exit the service provider geolocation and/or the number of times individual user(s) perform location-based actions in the service provider geolocation (e.g., receive and/or respond to remote service provider computing system requests). In another example, the system can store a set of information in a database and/or digital ledger each time a location-based event occurs with respect to the service provider geolocation in a given duration and transmit the sets of information to the remote service provider computing systems after the given duration.

As used herein, a client device, a guest device, a computing device, and/or a mobile computing device refer to devices corresponding to desktop computer(s), cellular devices or smartphones, personal digital assistants (PDAs), laptop computer(s), tablet devices, etc., that can provide network connectivity and processing resources for communicating with a system(s) over one or more networks, such as a guest service arrangement system.

Still further, examples described herein relate to a variety of location-based (and/or on-demand) services, such as a hospitality service associated with restaurants, theatres, shopping malls, concert venues, gaming venues, resorts, theme parks, hotels, airlines, etc. to be arranged between users(s) and remote service provider computing systems. In other examples, a guest service arrangement system can be implemented by any entity that provides goods or services for purchase through the use of computing devices and network(s). For purpose of simplicity, in examples described herein, the guest service arrangement system can correspond to a hospitality arrangement system that arranges hospitality services to be provided for users(s) by remote service provider computing systems.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device (such as a data store, a hard drive, a flash memory, a magnetic memory, a non-transitory data storage, digital ledger, or other data storage means). The term “data store” as used herein is intended to cover any implementation of data storage (e.g., digital ledgers such as blockchain databases) as would be appreciated by a person skilled in the art. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computer(s), cellular or smartphones, personal digital assistants (e.g., PDAs), laptop computer(s), printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computer(s) or servers. Other examples of computer storage mediums include portable storage units, such as CD or DVD units, flash memory (such as carried on smartphones, multifunctional devices or tab-lets), and magnetic memory. Computer(s), terminals, network enabled devices (e.g., mobile devices, such as cell phones) are all examples of machines and devices that utilize processors, memory, and instructions stored on computer-readable mediums, and/or digital ledgers. Additionally, examples may be implemented in the form of computer-programs, or a computer usable carrier medium capable of carrying such a program.

These and other aspects of the present invention will become apparent from the disclosure herein.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure. In the figures:

FIG. 1 is a diagram of an exemplary embodiment of a contactless payment system for hospitality services.

FIG. 2 illustrates an exemplary method for performing location-based operations in connection with a hospitality service.

FIG. 3 is a block diagram illustrating a mobile computing device upon which embodiments described herein may be implemented.

FIG. 4 is a block diagram illustrating a computer system upon which examples described herein may be implemented.

### DETAILED DESCRIPTION

The term “user computing device” as used herein means any computing device which a user may use to interact with the systems of the present disclosure or which a user may use to engage with the methods of the present disclosure. In preferred embodiments, the user computing device is “mobile computing device”. Typically, a “user computing device” will have network and/or internet access, will be capable of running an application and performing biometric authentication. In an embodiment, one or more user computing devices may be implemented and/or one or more user computing devices may be utilized at various steps in the methods herein or at various points/times of interaction with the systems herein, the one or more user computing devices each being capable of logging in to the user's account with the system/application. It can be appreciated that recitation of the term “mobile computing device” is encompassing of any “user computing device” capable of performing the same, required, or desired functions.

The term “biometric authentication” as used herein is synonymous with “biometric authorization”, “biometric identification”, and like terms. “Biometric authentication” is an authentication based upon one or more biometric inputs to a user computing device. In some embodiments, biometric authentication includes fingerprint, facial recognition, eye/iris recognition, voice recognition, palm recognition, vein pattern recognition (retinal or finger/skin), or any other known biometric authentication. These authentications are commonly implemented on user computing devices, such as mobile computing devices.

The term hospitality service is intended to include a wide range of venues including restaurants, hotels, shopping malls, cruise ships, airlines, theatres, gaming venues, stadiums, resorts, theme parks, concert venues, and the like.

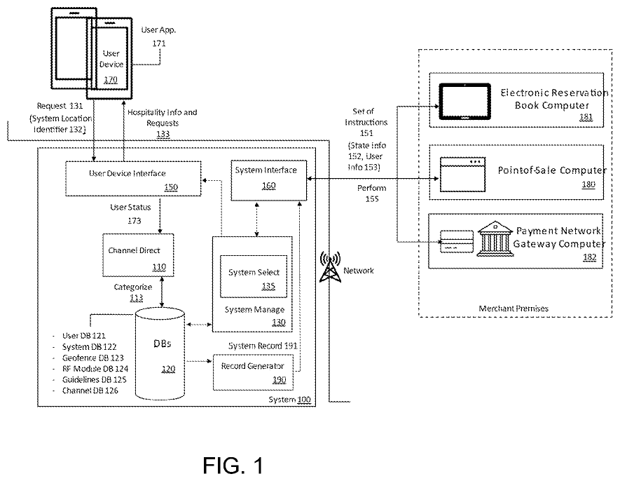

FIG. 1 illustrates an example system to perform location-based operations in connection with a hospitality service. In the example of FIG. 1, a system 100 can be in communication with or be a part of a guest service arrangement system, such as a hospitality arrangement system. The system 100 can include a number of components including a channel direct 110, a plurality of databases 120, a system manage 130, a user device interface 150, and a system interface 160. The components of the system 100 can combine to perform selective operations for select point-of-sale (POS) computer(s) 180, electronic reservation book (ERB) computer(s) 181, and payment gateway computer(s) 182 based on location data provided by user devices 170. Logic can be implemented with various applications (e.g., software) and/or with hardware of the computing device that implements the system 100.

The “point of sale” computer, or “POS” computer 180 as used herein is a computer with which the system 100 communicates in order to place orders for hospitality services and which accepts input information from the application 171 running on the user computing device 170 and which accepts related instructions from the system 100.

The “electronic reservation book” computer, or “ERB” computer 181 as used herein is a computer with which the system 100 communicates to manage reservations, seating, location services, and other related services, and which accepts related instructions from the system 100.

The “payment gateway” computer 182 as used herein is a computer with which the system 100 communicates to provide authorized payment information. The “payment gateway” communicates, typically over the internet, with one or more financial institutions to facilitate payment from a user's credit card. The “payment gateway” may also facilitate payment from other services such as Apple Pay, PayPal, or other services. The “payment gateway” may also be enabled to perform cryptocurrency transactions.

The POS 180, ERB 181, and payment gateway 182 are preferably separate computer(s) capable of communicating with the system 100 over one or more networks to transmit and receive any required information. It is contemplated that the functions of the POS 180, ERB 181, and payment gateway 182 could be condensed into one, or two computer(s) rather than three computer(s), and any computer or computer(s) performing these functions are contemplated in alternative embodiments.

In some examples, the system 100 can be implemented by, and operated on, a computing system(s) through execution of instructions stored in one or more memory resources of the computing system(s.) The system 100 can be implemented on network side resources, such as on one or more servers or data centers, or implemented through other computer systems in alternative architectures such as digital ledgers (e.g., blockchain). According to some examples, different components of the system 100 can be implemented on different computing systems that are in communication with each other. In the example of FIG. 1, the system 100 can include a user device interface 150 to exchange data with a plurality of user devices 170. Similarly, the system 100 can include a system interface 160 to exchange data with one or more point-of-sale (POS) computer(s) 180, electronic reservation book (ERB) computer(s) 181, and payment gateway computer(s) 182. The user device interface 150 and the system interface 160 can use one or more network resources of the computing system to exchange communications over one or more wireless networks (e.g., a cellular transceiver, a WLAN transceiver, etc.).

Each of the user devices 170 can store and run a respective user application 171 (a client-side application) that can interface with the user device interface 150. For example, the user application 171 can include or use an application programming interface (API), such as an externally facing API, to communicate data with the system 100. The externally facing API can provide access to the system 100 via secure access channels over the network through any number of methods, such as web-based forms, programmatic access via restful APIs, Simple Object Access Protocol (SOAP), remote procedure call (RPC), scripting access, etc. Similarly, the point-of-sale (POS) computer 180, electronic reservation book (ERB) computer 181, and payment gateway computer 182 can also each store and run a respective client application (also referred to herein as a hospitality application) that can interface with the system interface 160 to communicate with the system 100. An administrative user operating a point-of-sale (POS) computer 180, electronic reservation book (ERB) computer 181, and payment gateway computer 182 can view information about a hospitality service and send information and/or requests to a user device 170 and/or point-of-sale (POS) computer 180, electronic reservation book (ERB) computer 181, and payment gateway computer 182 using the hospitality application.

As described herein, an individual user (e.g., guest) can have an associated account with the system 100 in order to receive communications from the system 100 in connection with hospitality services. For example, when a point-of-sale (POS) computer(s) 180, electronic reservation book (ERB) computer(s) 181, and payment gateway computer(s) 182 receives hospitality updates to provide hospitality services from the system 100 (e.g., when the point-of-sale (POS) computer(s) 180, electronic reservation book (ERB) computer(s) 181, and payment gateway computer(s) 182 provides hospitality services to a user using the platform provided by the guest service arrangement system), the user can launch a respective user application 171 on the user's respective user device 170 and/or sign in using credentials associated with the user's account. The user application 171 can operate in any one of a plurality of states, including, for example: (i) a signed-in state, e.g., after the user logs in with his or her credentials, the user has not yet indicated via user input on the user application 171 that he or she has selected an available service provider from a list of service providers to provide a hospitality service from one or more point-of-sale (POS) computer(s) 180, electronic reservation book (ERB) computer(s) 181, and payment gateway computer(s) 182 associated with the service provider, (ii) an authenticated state, e.g., after the user has indicated via user input on the user application 171 that he or she has selected an available service provider from a list of service providers to provide a hospitality service from one or more point-of-sale (POS) computer(s) 180, electronic reservation book (ERB) computer(s) 181, and payment gateway computer(s) 182 associated with the service provider and has successfully performed one or more biometric authentication method(s), (iii) a shared location identifier state, e.g., after the user has been authenticated and has indicated permissions to share a location identifier (e.g., table number and/or seating location) with other user application(s) 171 via user input on the user application 171 (as an example, a user might share their location so that an individual may send them a gift, such as a bottle of wine in a restaurant setting, for a special occasion), (iv) an unauthenticated state, e.g., after the user has selected an available service provider to provide a hospitality service(s) but has failed to successfully perform one or more biometric authentication method(s) (and, as a result, no instructions can be communicated to the system), or (v) a suspended state, e.g., the user has committed fraudulent and/or other unacceptable behavior in association with a selected service provider and has been suspended from any further hospitality service in association with the respective service provider.

Depending on implementation, the user application 171 can provide user status information 173 to the system 100 once the user application 171 is launched and/or based on the state that the user application 171 is operating in. In one example, the user application 171 can periodically transmit the user status information 173 any time the user application 171 is running on the user device 170 (and/or is not in a suspended state), while in another example, the user application 171 can periodically transmit the user status information 173 only when the user is operating in a particular state(s), e.g., when the user application 171 is operating in the authenticated state. Still further, in some examples, as an addition or an alternative, the user application 171 can transmit the user status information 173 when the user application 171 changes states and/or in response to user input provided by the user on the user application 171.

According to examples, the user status information 173 can include one or more of (i) a user identifier (ID) and/or digital ledger identifier (ID) associated with the user, (ii) a device ID associated with the user device 170, (iii) an application ID associated with the user application 171, (iv) a state information corresponding to the state the user application 171 is operating in, or (v) a location data point corresponding to the current location of the user device 170 (e.g., a latitude and longitude coordinate), and/or an associated timestamp, a bearing, a date, and/or an error value of that location data point. The location data point (and its associated timestamp, bearing, date, and/or error value) can be generated by a global positioning system (GPS) receiver of the user device 170. In other examples, alternatively or additionally, the user device 170 can use one or more of other location determination mechanisms, such as Wi-Fi or cell tower triangulation or trilateration, to determine the location data point. The channel direct 110 can receive the user status information 173 from a plurality of user devices 170 and can continuously update a user database 121 with the information from the user status information 173.

Although the system 100 can include multiple user databases 121, for purpose of simplicity, the user database 121 is described as a single database in FIG. 1. Similarly, each of the other databases 120 can represent one or more respective databases in the example of FIG. 1. The user database 121 can store information about the user accounts with the system 100 as well as the location and state information for each user. For example, for each user application 171 running on a respective user device 170, the channel direct 110 can store the most up-to-date or most recent location and state information of each respective user in the user database 121, and/or store previous locations and previous state information of each respective user determined during a previous duration of time (e.g., the last day, the last week, or the last month).

In addition, the channel direct 110 can determine, based on respective location and/or state information, whether a user is currently located at a particular position or service provider geolocation (and/or is in a particular state) that causes the point-of-sale (POS) computer(s) 180, electronic reservation book (ERB) computer(s) 181, and payment gateway computer(s) 182 to be subject to a set of alternate operational guidelines (as opposed to default guidelines). For example, the channel direct 110 can access a geofence 123 and/or RF module database 124, which stores information about a plurality of geofences and/or RF modules. Each geofence and/or RF module entry stored in the geofence 123 and/or RF module database 124 can include a geofence ID and/or RF module ID and a set of location information to define the geofence and/or RF module, and/or can be associated with one or more guidelines (or include one or more guideline IDs). As described herein, a geofence can correspond to a geolocation or area and can be defined by a perimeter. A perimeter of a geofence can be defined in a variety of ways, e.g., using three or more location data points or can be defined using a radius value from a center location data point of the geofence (e.g., a circumference of a circular shaped geofence). An RF module can correspond to a geolocation or area and can be defined by a small electronic circuit used to receive, transmit or transceive radio waves on one of a number of carrier frequencies (e.g., 802.11/WLAN, 802.15.4/Zigbee, Bluetooth, Bluetooth Accessories, GPS, Proprietary RFID, UHF), through a functional integration of semiconductor devices. The geofence and/or RF module entries may be configurable by an administrative user of the system 100.

For individual users(s) that are operating the user application 171, the channel direct 110 can repeatedly perform a location check to determine whether any of the users(s) have entered or exited a specified service provider geolocation(s) or whether an event occurred while any of the users(s) are in a specific service provider geolocation(s). For example, for each user operating a user device 170, the channel direct 110 can receive a location data point corresponding to the current location of that user device 170 and check whether the location data point is positioned within any of the geofences and/or RF modules from the geofence 123 and/or RF module database 124. Because the user device 170 periodically provides a location data point to the channel direct 110 (e.g., even as the user travels or changes positions), the channel direct 110 can track the user's movement, update the user database 121, and periodically check whether the user has entered or exited a service provider geolocation associated with a geofence and/or RF module. In this manner, the channel direct 110 can perform the location check for an individual user each time the channel direct 110 receives the location data point from the user application 171 operated by that user.

If the channel direct 110 detects that a location-based event has occurred with respect to a particular geofence and/or RF module (e.g., a user has entered or exited a service provider geolocation associated with the geofence and/or RF module, or performed an action while positioned in a service provider geolocation associated with the geofence and/or RF module), the channel direct 110 can determine one or more guidelines associated with that geofence and/or RF module and/or perform an operation(s) associated with the one or more guidelines. According to an example, guidelines that are associated with geofences and/or RF modules can be stored in a guidelines database 125. One or more guidelines can specify what operation(s) or process(es) the system 100 is to perform for a particular point-of-sale (POS) computer(s) 180, electronic reservation book (ERB) computer(s) 181, and payment gateway computer(s) 182. As an addition or an alternative, once the channel direct 110 detects for a particular user that a location-based event has occurred with respect to a particular geofence and/or RF module, the channel direct 110 can determine a set of guidelines associated with that geofence and/or RF module, and categorize the point-of-sale (POS) computer(s) 180, electronic reservation book (ERB) computer(s) 181, and payment gateway computer(s) 182 as being subject to the set of guidelines. The channel direct 110 categorizes 113 the point-of-sale (POS) computer(s) 180, electronic reservation book (ERB) computer(s) 181, and payment gateway computer(s) 182 as being subject to a set of guidelines by adding the point-of-sale (POS) computer(s), electronic reservation book (ERB) computer(s), and payment gateway computer system location identifiers ID(s) 132 (e.g., address, port, socket, or other associated identifier such as a device ID) to a channel.

In some examples, a location-based event can depend on a particular state of the user application 171. The channel direct 110, for example, can use both the location information and state information of a user to determine whether a location-based event has occurred. In one use case example, for a particular geofence and/or RF module, a point-of-sale (POS) computer(s) 180, electronic reservation book (ERB) computer(s) 181, and payment gateway computer(s) 182 can be categorized 113 as being subject to a set of guidelines when the user has entered a service provider geolocation associated with that geofence and/or RF module and when the user application 171 is also operating in a particular state(s) (e.g., is in an authenticated state). In such an example, if the user application 171 is in an unauthenticated state or suspended state, the channel direct 110 may determine that no location-based event occurred even if the user enters and exits a service provider geolocation associated with that geofence and/or RF module.

As described herein, a set of guidelines associated with a geofence and/or RF module can instruct the system 100 to manage a set of point-of-sale (POS) computer(s) 180, electronic reservation book (ERB) computer(s) 181, and payment gateway computer(s) 182 (that are associated with the service provider geolocation of the geofence and/or RF module) differently than if the set of point-of-sale (POS) computer(s) 180, electronic reservation book (ERB) computer(s) 181, and payment gateway computer(s) 182 was subject to default guidelines (e.g., by categorizing those point-of-sale (POS) computer(s) 180, electronic reservation book (ERB) computer(s) 181, and payment gateway computer(s) 182 as being subject to the specified set of guidelines and/or by performing one or more operations for those point-of-sale (POS) computer(s) 180, electronic reservation book (ERB) computer s) 181, and payment gateway computer s) 182). According to some examples, when point-of-sale (POS) computer(s) 180, electronic reservation book (ERB) computer s) 181, and payment gateway computer s) 182 are subject to default guidelines, the system 100 can operate default or normal operations in connection with hospitality services. As referred to herein, default operations can correspond to or include a default guest service arrangement process for requesting user(s) and select point-of-sale (POS) computer(s) 180, electronic reservation book (ERB) computer s) 181, and payment gateway computer s) 182.

Referring to FIG. 1, the system 100 can include a hospitality service (or system) manage 130 that can receive a request 131 for a hospitality service that was generated and transmitted by a user device operated by a requesting user. The request 131 can include a specified system location identifier(s) 132 (e.g., an address, port, or socket of the point-of-sale (POS) computer(s) 180, electronic reservation book (ERB) computer(s) 181, and payment gateway computer(s) 182, and can include information associated with the user. The system manage 130 can create a hospitality entry associated with the request 131 and store the hospitality entry (along with other hospitality entries) in the system database 122. The system manage 130 can also include a system select 135 that performs a point-of-sale (POS) computer(s) 180, electronic reservation book (ERB) computer(s) 181, and payment gateway computer(s) 182 selection process in order to select a point-of-sale (POS) computer(s) 180, electronic reservation book (ERB) computer(s) 181, and payment gateway computer(s) 182 to provide the hospitality service for the user. In some examples, in accordance with the default hospitality arrangement process, the system select 135 can identify a set of point-of-sale (POS) computer(s) 180, electronic reservation book (ERB) computer(s) 181, and payment gateway computer(s) 182 (e.g., those that are capable of providing the hospitality service for the user) based on the current location information of the users(s) in the user database 121, and select a point-of-sale (POS) computer(s) 180, electronic reservation book (ERB) computer(s) 181, and payment gateway computer(s) 182 from the set of available point-of-sale (POS) computer(s) 180, electronic reservation book (ERB) computer(s) 181, and payment gateway computer(s) 182 in the system database 122. The system select 135 can identify the set of available point-of-sale (POS) computer(s) 180, electronic reservation book (ERB) computer(s) 181, and payment gateway computer(s) 182 by determining which users(s) transmitted a request 131 within a predetermined radius of the service provider geolocation associated with the system location identifier 132 and can select the point-of-sale (POS) computer(s) 180, electronic reservation book (ERB) computer(s) 181, and payment gateway computer(s) 182 from the set based on certain guidelines, e.g., by determining which user(s) transmitted a request 131 outside the service provider geolocation associated with the system location identifier 132.

In addition, in accordance with the default hospitality arrangement process, once the point-of-sale (POS) computer(s) 180, electronic reservation book (ERB) computer(s) 181, and payment gateway computer(s) 182 is selected, the system manage 130 can transmit a set of instructions 151 to the selected point-of-sale (POS) computer(s) 180, electronic reservation book (ERB) computer(s) 181, and payment gateway computer(s) 182. The set of instructions 151 can include state information 152 (e.g., generate a reservation identifier (ID) corresponding to the system location identifier(s) 132, user information 153 (e.g., a user identifier (ID) associated with the user, a digital ledger identifier (ID) associated with the user (e.g., blockchain, non-fungible token), a name, a photograph, phone number, e-mail address, a device (ID) associated with the user device 170, an application (ID) associated with the user application 171, a date associated with a reservation request, a time associated with a reservation request, a party size associated with a reservation request, a user VIP identifier (ID) that indicates a VIP user status (e.g., Very Important Person), user notes indicating food allergies, food and/or drink preferences, prior orders, number of visits, etc.). If the point-of-sale (POS) computer(s) 180, electronic reservation book (ERB) computer(s) 181, and payment gateway computer(s) 182 performs 155 the set of instructions 151, the system manage 130 can receive indication of the performance, update the associated hospitality entry in the system database 122, and can provide hospitality information and/or requests 133 (e.g., a reservation identifier (ID) that identifies the record in association with the request, etc.) to the requesting user device 170. The system manage 130 can then track the performance of the hospitality service by monitoring the location of the user and update the hospitality entry accordingly.

The system manage 130 can also perform alternate operations (as compared to operations performed in connection with the default hospitality arrangement process) for one or more point-of-sale (POS) computer(s) 180, electronic reservation book (ERB) computer(s) 181, and payment gateway computer(s) 182 that are categorized as being subject to a set of guidelines different from the default guidelines. For example, a particular geofence and/or RF module can be associated with a set of guidelines that instructs the system select 135 to manage those point-of-sale (POS) computer(s) 180, electronic reservation book (ERB) computer(s) 181, and payment gateway computer(s) 182 differently when a user device 170 is located in a service provider geolocation associated with that geofence and/or RF module than those that are not in the service provider geolocation. In one example, the set of guidelines can cause the channel direct 110 to include the point-of-sale (POS) computer(s) 180, electronic reservation book (ERB) computer(s) 181, and payment gateway computer(s) 182 system location identifier(s) 132 of those point-of-sale (POS) computer(s) 180, electronic reservation book (ERB) computer s) 181, and payment gateway computer s) 182 in a channel (such as a channel stored in a channels database 126). An example of a channel can correspond to a plurality of operational states for the point-of-sale (POS) computer(s) 180, electronic reservation book (ERB) computer s) 181, and payment gateway computer s) 182 that the system select 135 can use to perform a point-of-sale (POS) computer s) 180, electronic reservation book (ERB) computer s) 181, and payment gateway computer s) 182 selection process. When the channel direct 110 determines that a location-based event has occurred with respect to the service provider geolocation associated with that geofence and/or RF module, such as when a user device 170 enters or exits the service provider geolocation based on the location data provided by the user device 170 or when the user performs some action for a hospitality service with a service provider in that service provider geolocation and the user application 171 is operating in a particular state (e.g., an authenticated state), for example, the system select 135 can determine the appropriate state from a plurality of states associated with that geofence and/or RF module and can select the point-of-sale (POS) computer s) 180, electronic reservation book (ERB) computer(s) 181, and payment gateway computer(s) 182 from the state in which the point-of-sale (POS) computer s) 180, electronic reservation book (ERB) computer(s) 181, and payment gateway computer s) 182 is operating in (e.g., entry, exit, order request, pending item, identified seating, payment authorization, check request, payment capture, unsuccessful payment capture, successful payment capture), as opposed to selecting the point-of-sale (POS) computer(s) 180, electronic reservation book (ERB) computer s) 181, and payment gateway computer s) 182 in response to a request 131 for a hospitality service outside the service provider geolocation associated with the system location identifier 132. In this manner, the system select 135 can perform alternate operations (or operate in a different mode than a default mode) for a set of point-of-sale (POS) computer(s) 180, electronic reservation book (ERB) computer s) 181, and payment gateway computer s) 182 in accordance with the set of guidelines associated with the geofence and/or RF module, as compared to the default operations in connection with hospitality services.

According to examples, the point-of-sale (POS) computer 180, electronic reservation book (ERB) computer 181, and payment gateway computer 182 can operate in any one of a plurality of states, including, for example:
(i) an entry state, e.g., after the user device 170 has entered a service provider geolocation associated with that geofence and/or RF module the point-of-sale (POS) computer 180 can generate and/or display a moveable (e.g., drag and drop) open check into an illuminable touch-sensitive queue that when selected displays the one or more moveable open checks in a region on the GUI screen display with a distinctive illumination treatment (e.g., highlight, flash, colored, etc.), generate and/or display an illuminable touch-sensitive user profile button configured as a selectable GUI widget in a region on the open check with a distinctive illumination treatment (e.g., highlight, flash, colored, etc.) that when selected initiates a pop-up window indicating user information (e.g., a user identifier (ID) associated with the user, a digital ledger identifier (ID) associated with the user (e.g., blockchain, non-fungible token), a name, a photograph, a phone number, e-mail address, a device (ID) associated with user device 170, an application (ID) associated with the user application 171 a time when the system determined that the user device 170 entered the service provider geolocation, a reservation identifier (ID) associated with a reservation record, a date associated with a reservation record, a time associated with a reservation record, a party size associated with a reservation record, a user VIP identifier (ID) that indicates a VIP user status, (e.g., Very Important Person), user notes indicating food allergies, food and/or drink preferences, prior orders, number of visits, etc.), generate and display an illuminable touch-sensitive transfer check button configured as a selectable GUI widget in a region on the moveable open check with a distinctive illumination treatment (e.g., highlight, flash, colored, etc.) that when selected initiates a pop-up window requesting input for a location identifier (e.g., seat, table number) associated with a seating location that when entered transfers the corresponding moveable open check to the seating location associated with the location identifier, the electronic reservation book (ERB) computer 181 can generate and/or display a moveable (e.g., drag and drop) reservation into an illuminable touch-sensitive queue that when selected displays the one or more moveable reservations in a region on the GUI screen display with a distinctive illumination treatment (e.g., highlight, flash, colored, etc.) in response to detecting a user application 171 associated with a reservation identifier (ID), generate and display an illuminable touch-sensitive user profile button configured as a selectable GUI widget in a region on the moveable reservation with a distinctive illumination treatment (e.g., highlight, flash, colored, etc.) that when selected initiates a pop-up window indicating user information (e.g., a user identifier (ID) associated with the user, a digital ledger identifier (ID) associated with the user (e.g., blockchain, non-fungible token), a name, a photograph, a phone number, e-mail address, a device (ID) associated with user device 170, an application (ID) associated with the user application 171 a time when the system determined that the user device 170 entered the service provider geolocation, a reservation identifier (ID) associated with a reservation record, a date associated with a reservation record, a time associated with a reservation record, a party size associated with a reservation record, a user VIP identifier (ID) that indicates a VIP user status, (e.g., Very Important Person), user notes indicating food allergies, food and/or drink preferences, prior orders, number of visits, etc.), generate and/or display a moveable (e.g., drag and drop) wait list entry into an illuminable touch-sensitive queue that when selected displays the one or more moveable wait list entries in a region on the GUI screen display with a distinctive illumination treatment (e.g., highlight, flash, colored, etc.) in response to detecting a user application 170 associated with a user identifier (ID), generate and display an illuminable touch-sensitive user profile button configured as a selectable GUI widget in a region on the moveable wait list entry with a distinctive illumination treatment (e.g., highlight, flash, colored, etc.) that when selected initiates a pop-up window indicating user information (e.g., a user identifier (ID) associated with the user, a digital ledger identifier (ID) associated with the user (e.g., blockchain, non-fungible token), a name, a photograph, a phone number, e-mail address, a device (ID) associated with user device 170, an application (ID) associated with the user application 171 a time when the system determined that the user device 170 entered the service provider geolocation, a waitlist identifier (ID) associated with the waitlist entry, a date associated with the waitlist entry, a time associated with the waitlist entry, a party size associated with the waitlist entry, a user VIP identifier (ID) that indicates a VIP user status, (e.g., Very Important Person), user notes indicating food allergies, food and/or drink preferences, prior orders, number of visits, etc.);
(ii) an order request state, e.g., after the user has selected a start order button on the user application 171 the point-of-sale (POS) computer 180 can automatically display in the top of the queue with a distinctive illumination treatment (e.g., highlight, flash, colored, etc.) the moveable open check and/or identifier (ID) associated with the moveable open check corresponding to the user (iii) a pending item state, e.g., after an administrative user has entered on the point-of-sale (POS) computer 180 one or more one or more menu line item(s) (e.g., food and beverage or other products or services) and/or after a user has selected one or more menu line item(s) selectable GUI widgets from the illuminable touch-sensitive menu line item (e.g., food, beverage, or other products or services) buttons on the user application 171, the point-of-sale (POS) computer 180 can generate and display one or more menu line item(s) (e.g., food and beverage or other products or services) as moveable widgets (e.g., drag and drop) in a region on the corresponding moveable open check with a distinctive illumination treatment (e.g., highlight, flash, colored, etc.) that when selected activate one or more modifiers to (e.g., food allergies, guest requests, special orders, item coursing and/or any other menu line item's specifications and additions) for the corresponding selected menu line item, generate and display an illuminable touch-sensitive fire order button configured as a selectable GUI widget in a region on the open moveable check that when selected fires one or more menu line item(s) to kitchen staff, (iv) an identified seating state, e.g., after an administrative user has moved a moveable reservation and/or wait list entry from a queue to a seating location displayed in a seat map on the GUI screen display in the electronic reservation book (ERB) computer 181 and/or entered a location identifier in the point-of-sale (POS) computer 180 in response to a selected transfer check button, transmit to the corresponding moveable open check in the point-of-sale (POS) computer 180 the location identifier (e.g., seat, table number) and/or automatically transfer the open check to the seating location associated with the corresponding location identifier, (v) a payment authorization state, e.g., after an administrative user has entered on the point-of-sale (POS) computer 180 one or more one or more menu line item(s) and/or after a user has selected one or more menu line item(s) selectable GUI widgets from the illuminable touch-sensitive menu line item (e.g., food, beverage, or other products or services) buttons on the user application 171 totaling a pre-determined authorization limit set by the service provider (e.g., the authorization limit may vary from service provider to service provider, and could be based upon the nature of the service provider. For example, if the service provider is a “casual” establishment then the pre-determined authorization limit amount might be $100, whereas if the service provider establishment is “upscale,” then the authorization amount might be $500), initiate the payment gateway computer 182 to authorize but not yet capture a payment amount, generate and display a notification and/or alert with a distinctive illumination treatment (e.g., highlight, flash, colored, etc.) in the point-of-sale (POS) computer 180 on a moveable open check region on the GUI screen display indicating an unsuccessful payment authorization and/or request for an alternate or backup payment source (e.g., another credit card on file) in response to an unsuccessful payment authorization in the payment gateway computer 182, (vi) a check request state, e.g., after a user has selected an illuminable touch-sensitive check request button configured as a selectable GUI widget on the user application 171, the point-of-sale (POS) computer 180 can generate and display a notification and/or alert with a distinctive illumination treatment (e.g., highlight, flash, colored, etc.) in a moveable open check region on the GUI screen display indicating a request to pay a check, an illuminable touch-sensitive send payment button configured as a selectable GUI widget in the corresponding moveable open check region, (vii) a payment capture state, e.g., after an administrative user has confirmed the total check amount and selected the illuminable touch-sensitive send payment button in the point-of-sale (POS) computer 180 and/or after a user has received the total check amount (e.g., total check amount associated with a plurality of selectable gratuity rate value blocks, expressed as percentages of the total check amount (e.g., gratuity rates include 18%, 20%, and 25% of the check total) and/or other gratuity rates (e.g., cash tips) from the point-of-sale (POS) computer 180 and has selected an illuminable touch-sensitive pay button configured as a selectable GUI widget, request the payment gateway computer 182 to capture the previously authorized amount and request to authorize and capture the difference between the final total ticket amount (e.g., tax, gratuity, and any other current charges) and previously authorized amount and/or request to authorize and capture the final total ticket amount (e.g., tax, gratuity, and any other current charges) upon detecting no prior authorization, (viii) an unsuccessful payment capture state, e.g., after a user has selected an illuminable touch-sensitive pay button on the user application 171 and the payment gateway computer 182 has unsuccessfully captured a final total ticket amount, request the point-of-sale (POS) computer 180 to generate and display a notification and/or alert with a distinctive illumination treatment (e.g., highlight, flash, colored, etc.) in a moveable open check region on the GUI screen display indicating an unsuccessful payment capture and/or request for an alternate or backup payment source (e.g., another credit card on file), (ix) a successful payment capture state, e.g., after a user has selected an illuminable touch-sensitive pay button on the user application 171 and the payment gateway computer 182 has successfully captured a final total ticket amount, request the point-of-sale (POS) computer 180 to generate and display a notification and/or alert with a distinctive illumination treatment (e.g., highlight, flash, colored, etc.) in a moveable open check region on the GUI screen display indicating a provisional electronic receipt, request the electronic reservation book (ERB) computer 181 to generate and display a confirmed payment message with a distinctive illumination treatment (e.g., highlight, flash, colored, etc.) for the seating location corresponding to the provisional electronic receipt associated with the location identifier displayed on the seat map region of the GUI screen display, (x) an exit state, e.g., after the user device 170 has traveled a fixed distance and/or exceeded a given time duration outside the virtual perimeter of the service provider geolocation and/or RF module (e.g., a pre-determined distance and/or exceeded time duration outside the virtual perimeter of the service provider geolocation and/or RF module may vary from service provider to service provider, and could be based upon the nature of the service provider) with a remaining balance on a moveable open check, request the payment gateway computer 182 to capture the previously authorized amount and request to authorize and capture the difference between the final total ticket amount (e.g., tax, gratuity, and any other current charges) and previously authorized amount and/or request to authorize and capture the final total ticket amount (e.g., tax, gratuity, and any other current charges) upon detecting no prior authorization, request the point-of-sale (POS) computer 180 to generate and display a notification and/or alert with a distinctive illumination treatment (e.g., highlight, flash, colored, etc.) in a moveable open check region on the GUI screen display indicating a balance due message, generate and display an illuminable touch-sensitive capture payment button configured as a selectable GUI widget in a moveable open check region on the GUI screen display, generate and display a notification and/or alert with a distinctive illumination treatment (e.g., highlight, flash, colored, etc.) in a moveable open check region on the GUI screen display indicating an unsuccessful payment capture and/or request for an alternate or backup payment source (e.g., another credit card on file) in response to an unsuccessful payment capture in the payment gateway computer, generate and display a notification or alert with a distinctive illumination treatment (e.g., highlight, flash, colored, etc.) in a moveable open check region on the GUI screen display indicating a provisional electronic receipt in response to a successful payment capture, request to automatically close a moveable open check associated with a provisional electronic receipt, request the electronic reservation book (ERB) computer 181 to generate and display a confirmed payment message with a distinctive illumination treatment (e.g., highlight, flash, colored, etc.) for the seating location corresponding to the provisional electronic receipt associated with the location identifier displayed on the seat map region of the GUI screen display in response to a successful payment capture, request the electronic reservation book (ERB) computer 181 to automatically remove a reservation and/or waitlist entry associated with user information 153.

In another example, each time a location-based event occurs with respect to a particular geofence and/or RF module, the system 100 can keep track of each instance in a given duration of time (e.g., increment a counter) and/or can store a set of information associated with that event, such as the set of user and/or remote service provider computing systems information described, in a memory resource (e.g., digital ledger, or a local memory resource or one that is accessible by the system 100 over one or more networks). The system 100 can use the stored information for a variety of purposes, such as for seating pattern recognition (e.g., the duration of time a guest(s) remains at a service provider location and/or table location of the service provider), accounting, for internal auditing, for safety/regulatory purposes (e.g., to have a detailed record of where guests are dining and for how long).

For example, the system 100 can keep track of how many times, in a give duration (e.g., in a week or a month), users(s) have entered and/or exited a service provider geolocation (e.g., such as at a region that includes a hospitality venue, and store such information in a database and/or digital ledger of the plurality of database 120. A geofence and/or RF module can be associated with the hospitality venue and can cover a geolocation that includes the hospitality venue and its surrounding areas. A record generator component 190 of the system 100 can access the database and/or digital ledger in order to generate a record(s) 191 for use with any of the variety of purposes. In one example, the record generator 190 can access the database and/or digital ledger to generate and provide a record(s) 191 to an entity and/or point-of-sale (POS) computer(s) 180, electronic reservation book (ERB) computer(s) 181, and payment gateway computer(s) 182 associated with that geolocation/geofence and/or RF module (e.g., a hospitality entity). For example, the record 191 can indicate the number of times users(s) have entered and/or exited the hospitality venue for purposes of providing hospitality services, and/or the duration of time a guest(s) has remained at a seating location given the size of the party for purpose of automatically assigning seating locations for guest(s) prior to arrival based on the history of their seating patterns (e.g., how long they stayed at a particular seating location based on the size of their party). In other examples the record 191 can also include detailed sets of information associated with each of the occurrences.

The record generator component 190 can generate the record 191 based on a predetermined schedule, periodically (e.g., at the end of the day, every week, or month), or in response to administrative user input. For example, for a give duration, the record generator component 190 can use the information associated with the geofence and/or RF module (e.g., the number of times users(s) have entered and/or exited the hospitality vendor for purpose of providing hospitality services, and/or the duration of time a guest(s) has remained at a seating location based on the party size) to determine a recognized pattern of seating (e.g., length of time a guest(s) remains at a given table location) for purpose of assigning table locations for guest(s) prior to entry. The record(s) 191 can be provided to the entity and/or point-of-sale (POS) computer(s) 180, electronic reservation book (ERB) computer(s) 181, and payment gateway computer(s) 182 via the system interface 160 or via another portal or other communication mechanism, such as via an e-mail communication or a webpage content, using the respective entity information (e.g., from the system database 122).

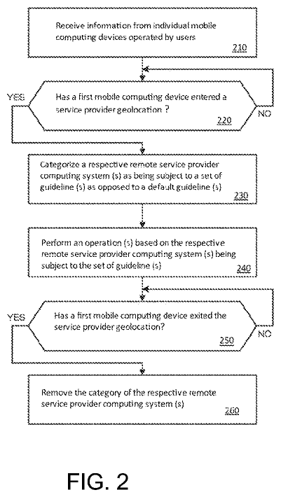

FIG. 2 illustrates an example method for performing location-based operations in connection with a hospitality service. A method such as described by an example of FIG. 2 can be implemented using, for example, components described with an example of FIG. 1. Accordingly, references made to elements of FIG. 1 are for purposes of illustrating a suitable element or component for performing a step or sub-step being described.

Referring to FIG. 2, the system 100 can receive information from individual mobile computing devices operated by users(s) (210). Each user can operate a user application 171 on the respective user device 170 that periodically transmit user status information 173 to the system 100. The user status information 173 can include one or more of (i) a user identifier (ID) and/or digital ledger identifier (ID) associated with the user, (ii) a device ID associated with the user device 170, (iii) an application ID associated with the user application 171, (iv) a state information corresponding to the state the user application 171 is operating in, or (v) a location data point corresponding to the current location of the user device 170. The system 100 can continuously store and update the user database 121 with the information received from the user devices 170.

The system 100 can also determine, based on the location information received from the user devices, whether any of the user devices has entered a service provider geolocation associated with a geofence and/or RF module (220). According to some examples, the channel direct 110 can perform a location check of each location data point received from a user device to determine whether that location data point is positioned within any service provider geolocation specified by geofences in the geofence database 123 and/or RF modules in the RF module database 124. If no mobile computing devices have entered any specified service provider geolocations, the channel direct 110 can continue to receive user status information 173 and perform location checks. On the other hand, if the channel direct determines that a mobile computing device has entered a particular service provider geolocation, the channel direct 110 can categorize the remote service provider computing system(s) as being subject to a first set of guidelines associated with the geofence and/or RF module (as compared to default guidelines that the remote service provider computing systems would have been subject to if the mobile computing device was outside the service provider geolocation or in another region) (230). The first set of guidelines can specify how the system 100 is to handle the remote service provider computing systems (as well as other remote service provider computing system(s) that are also categorized as being subject to the first set of guidelines) and/or what operations or processes to perform for the remote service provider computing systems that are different from default operations. In one example, the channel direct 110 can categorize the remote service provider computing systems as being subject to a first set of guidelines by adding the remote service provider computing system(s) ID(s) to a channel. The system 100 can also perform one or more operations in connection with the remote service provider computing system(s) based on the remote service provider computing system(s) being categorized as being subject to the first set of guidelines (240). In some variations, the system 100 may not perform any operations for the remote service provider computing system(s) if no operations are necessary. For example, the mobile computing device may have entered the service provider geolocation, but then provided input on the user application 171 that did not authenticate or close/turn off the user application 171, or may have exited the service provider geolocation before the remote service provider computing system(s) was subject to any remote service provider computing system(s) selection process by the system 100.

The system 100 can also detect, based on the location information received from the mobile computing device(s), whether the mobile computing device has exited the service provider geolocation (250). For example, as the mobile computing device travels or changes position and the user device 170 provides user status information 173, the channel direct 110 can continue to check whether the mobile computing device has exited the service provider geolocation. If the mobile computing device has not exited the service provider geolocation, the system 100 can continue to perform one or more operations, as necessary, specified by the first set of guidelines. On the other hand, if the channel direct 110 determines that the mobile computing device has exited the service provider geolocation, the channel direct 110 can remove the existing categorization of the remote service provider computing system(s) to enable the remote service provider computing system(s) to no longer be subject to the first set of guidelines (and instead, be subject to the default guidelines) (260).

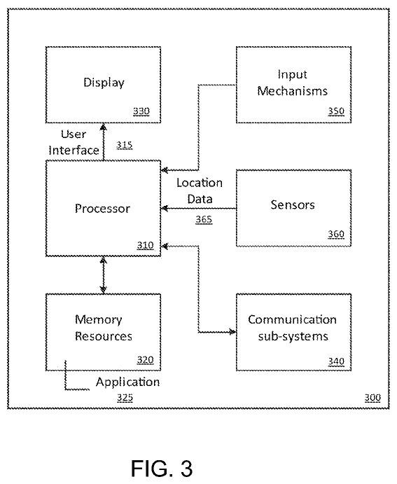

FIG. 3 is a block diagram that illustrates a mobile computing device upon which embodiments described herein may be implemented. In one example, a computing device 300 may correspond to a mobile computing device, such as a cellular device that is capable of telephony, messaging, and data services. The computing device 300 can correspond to a client device or a guest device. Examples of such devices include smartphones, handsets or tablet devices for cellular carriers. The computing device 300 includes a processor 310, a memory resources 320, a display device 330 (e.g., such as a touch-sensitive display device), one or more communication sub-systems 340 (including wireless communication sub-systems), input mechanisms 350 (e.g., an input mechanism can include or be part of the touch-sensitive display device), and one or more sensors 360, including a location detection mechanism (e.g., GPS receiver). In one example, at least one of the communication sub-systems 340 sends and receives cellular data over data channels and voice channels. The communication sub-systems 340 can include a cellular transceiver and one or more short-range wireless transceivers.

The processor 310 can provide a variety of content to be displayed on the display 330 by executing instructions stored in the memory resources 320. The memory resources 320 can store instructions corresponding to the user application 325, for example, and other data, such as data associated with the user application 325 (e.g., hospitality entry data, user information, user authentication, etc.). For example, the processor 310 is configured with software and/or other logic to perform one or more processes, steps, and other functions described with implementations, such as described by FIGS. 1 through 2, and elsewhere in the application. In particular, the processor 310 can execute instructions and data corresponding to the user/guest application 325 in order to periodically receive or retrieve location data 365 corresponding to the current location of the computing device 300 and providing status information of the user/user application 325 to the guest service arrangement system (e.g., the system 100 of FIG. 1). The processor 310 can also execute the user application instructions 325 to cause various user interfaces 315 to be displayed on the display 330. The user interfaces 315 can correspond to user interfaces that are displayed in connection with the hospitality service, including a request user interface when a request is received from the system 100, and other user interfaces corresponding to respective user application states. The user interfaces 315 can also include selectable features to enable the user to provide input via the input mechanisms 350 to indicate changes in the user application state.

In one example, the computing device 300 can periodically determine a location data point 365 of the current location of the computing device 300 from the GPS receiver. In another example, the computing device 300 can determine the current location by using one or more transceivers or a GPS receiver of the communications sub-systems 340. While FIG. 3 is illustrated for a mobile computing device, one or more examples may be implemented on other types of devices, including full-functional computer(s), such as laptops and desktops (e.g., PC).

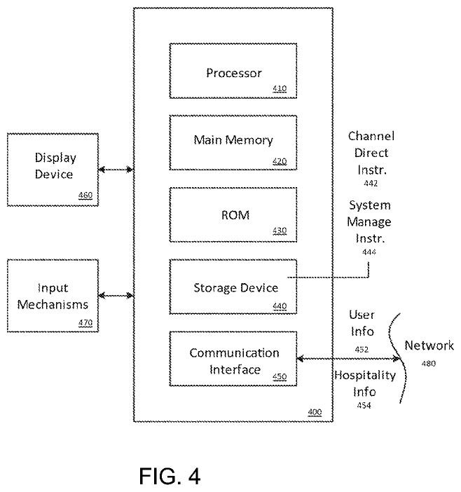

FIG. 4 is a block diagram that illustrates a computer system upon which examples described herein may be implemented. For example, in the context of FIG. 1, the guest service arrangement system (e.g., the system 100) may be implemented using a computer system such as described by FIG. 4. The guest service arrangement system may also be implemented using a combination of multiple computer systems as described by FIG. 4.

In one implementation, the computer system 400 includes processing resources, such as one or more processors 410, a main memory 420, a read-only memory (ROM) 430, a storage device 440, and a communication interface 450. The computer system 400 includes at least one processor 410 for processing information and the main memory 420, such as a random access memory (RAM) or other dynamic storage device, for storing information and instructions to be executed by the processor 410. The main memory 420 also may be used for storing temporary variables or other intermediate information during execution of instructions to be executed by the processor 410. The computer system 400 may also include the ROM 430 or other static storage device for storing static information and instructions for the processor 410. The storage device 440, such as a magnetic disk or optical disk, is provided for storing information and instructions.

For example, the storage device 440 can correspond to a computer-readable medium that stores channel direct instructions 442 and system manage instructions 444 for performing operations discussed with respects to FIGS. 1 and 2. In such examples, the computer system 400 can receive location data from a plurality of user devices, determine which users(s) have triggered a location-based event with respect to a service provider geolocation specified by a geofence and/or RF module, and perform alternate operations (as opposed to default operations) for or in connection with the remote service provider computing systems. In addition, the storage device 440 can store other data, such as data stored in the plurality of databases 120 of FIG. 1.

The communication interface 450 can enable the computer system 400 to communicate with one or more networks 480 (e.g., cellular network) through use of the network link (wirelessly or using a wire). Using the network link, the computer system 400 can communicate with a plurality of devices, such as the computing devices of the users(s) and/or remote service provider computing systems. According to some examples, the computer system 400 can receive user status information 452 from the user devices, and/or hospitality information 454 from the remote service provider computing systems such as described by some examples of FIGS. 1 and 2.

The computer system 400 can also include a display device 460, such as a cathode ray tube (CRT), an LCD monitor, or a television set, for example, for displaying graphics and information to a user. An input mechanism 470, such as a keyboard that includes alphanumeric keys and other keys, can be coupled to the computer system 400 for communicating information and command selections to the processor 410. Other non-limiting, illustrative examples of the input mechanisms 470 include a mouse, a trackball, touch-sensitive screen, or cursor direction keys for communicating direction information and command selections to the processor 410 and for controlling cursor movement on the display 460.

Examples described herein are related to the use of the computer system 400 for implementing the techniques described herein. According to one example, those techniques are performed by the computer system 400 in response to the processor 410 executing one or more sequences of one or more instructions contained in the main memory 420. Such instructions may be read into the main memory 420 from another machine-readable medium, such as the storage device 440. Execution of the sequences of instructions contained in the main memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### INCORPORATION BY REFERENCE

The entire disclosure of each of the patent documents, including certificates of correction, patent application documents, scientific articles, governmental reports, websites, and other references referred to herein is incorporated by reference herein in its entirety for all purposes. In case of a conflict in terminology, the present specification controls.

At certain points throughout some of the Examples of the specification, some references are referred to using a number in parentheses. Those numbers correspond to the references listed at the end of that particular example. Other references are cited within other parts of the specification and other references are cited separately.

### EQUIVALENTS

The invention can be embodied in other specific forms without departing from the spirit or essential characteristics thereof. The foregoing embodiments are to be considered in all respects illustrative rather than limiting on the invention described herein. In the various embodiments of the methods and systems of the present invention, where the term comprises is used with respect to the recited steps of the methods or components of the compositions, it is also contemplated that the methods and compositions consist essentially of, or consist of, the recited steps or components. Furthermore, it should be understood that the order of steps or order for performing certain actions is immaterial so long as the invention remains operable. Moreover, two or more steps or actions can be conducted simultaneously.

In the specification, the singular forms also include the plural forms, unless the context clearly dictates otherwise. Unless defined otherwise, all technical and scientific terms used herein have the same meaning as commonly understood by one of ordinary skill in the art to which this invention belongs. In the case of conflict, the present specification will control.

What is claimed is:

1. A contactless payment system comprising:
a computing system comprising one or more processors for executing computer-readable instructions;
one or more databases and/or digital ledgers for storing the computer-readable instructions,
a plurality of computing devices, the plurality comprising one or more point-of-sale (POS) computer(s), one or more electronic reservation book (ERB) computer(s), and one or more payment gateway computer(s);
one or more networks interconnecting the computing system and the plurality of computing devices by one or more internet and/or local connections;
a user computing device in data communication with the computing system, the user computing device comprising an application (including internet browser interface) configured to:
receive, from a user, user login credentials for the contactless payment system;
select a venue providing the services;
provide location data to the computing system; and
perform one or more biometric authentication method(s);
a geofence located at the [hospitality venue] for defining a geofenced area for the service and/or an RF module located at the venue for defining a proximity to the service,
wherein the computing system determines whether a user computing device is within the geofenced area and/or in proximity to an RF module.

2. The contactless payment system according to claim 1, wherein the system is for hospitality services for a hospitality venue, comprising:
a computing system comprising one or more processors for executing computer-readable instructions;
one or more databases and/or digital ledgers for storing the computer-readable instructions,
a plurality of hospitality computing devices, the plurality comprising one or more point-of-sale (POS) computer(s), one or more electronic reservation book (ERB) computer(s), and one or more payment gateway computer(s);
one or more networks interconnecting the computing system and the plurality of hospitality computing devices by one or more internet and/or local connections;
a user computing device in data communication with the computing system, the user computing device comprising an application (including internet browser interface) configured to:
receive, from a user, user login credentials for the contactless payment system;
select a hospitality venue providing the hospitality services;
provide location data to the computing system; and
perform one or more biometric authentication method(s);
a geofence located at the hospitality venue for defining a geofenced area for the hospitality service and/or an RF module located at the hospitality venue for defining a proximity to the hospitality service,
wherein the computing system determines whether a user computing device is within the geofenced area and/or in proximity to an RF module.

3. The system of claim 2, wherein the data is stored in a database and/or digital ledger, (e.g., a blockchain database) and/or a plurality of guidelines for the computer system and/or plurality of hospitality computing devices.

4. The system of claim 3, wherein the computer system and/or plurality of hospitality computing devices are set to a first, default guideline when the user computer device is not within the geofenced area and/or is not in proximity to an RF module, and wherein the computer system and/or plurality of hospitality computing devices are set to a second, alternate guideline when the user computer device is within the geofenced area and/or is in proximity to an RF module.

5. The system of claim 2, wherein the data is stored in a database and/or digital ledger, (e.g., blockchain database) and/or a plurality of user states for the computer system and/or plurality of hospitality computing devices.

6. The system of claim 5, wherein the computing system and/or plurality of hospitality computing devices are set to a first user state when the user has selected a venue providing the hospitality services and has performed one or more biometric authentication method(s), and wherein the user computing device and/or computing system are set to a second user state when the user has not performed one or more biometric authentication method(s).

7. The system of claim 6, wherein the computer system does not allow for the hospitality service to be rendered to the user in the second user state (where the user has not performed the required biometric authentication).

8. The system of claim 2, wherein the computer system and/or plurality of hospitality computing devices are set to one or more of a plurality of operational states, and wherein the operational states are selected or changed in accordance with events associated with the user computing device and/or plurality of hospitality computing devices.

9. The system of claim 8, wherein the operational states are selected from
(i) an entry state, where the user computing device has entered the geofence or is in proximity with an RF module;
(ii) an order request state, where the user utilizes the user computing device to begin an order (optionally, by communication with the POS computer);
(iii) a pending item state, where the user has selected particular hospitality services to be rendered but has not yet placed an order;
(iv) an identified seating state, where the system and/or plurality of hospitality computing devices are updated with the seating location for the user;
(v) a payment authorization state, where the user has pre-authorized payment for the hospitality services to be rendered, but the transaction has not yet occurred (the payment authorization is optionally required before the hospitality services may be rendered);
(vi) a check request state, where the user is presented with the option to complete the transaction for the hospitality services rendered;
(vii) a payment capture state, where the user may initiate the transaction for any pre-authorized or non-previously authorized balances;
(viii) an unsuccessful payment capture state, where the initiated transaction failed;
(ix) a successful payment capture state, where the initiated transaction succeeded; and
(x) an exit state, e.g., where the user computing device has exited the geofence or is no longer in proximity with an RF module, wherein the exit state may initiate a payment capture state if the user did not pay for the rendered hospitality services prior to the exit state being set (if user leaves the venue without paying).

10. A method for contactless payment of hospitality services, comprising the steps of:
communicating, over one or more networks, with a
plurality of computing devices of a plurality of
point-of-sale (POS) computer(s), electronic reservation book (ERB) computer(s), and payment gateway computer(s) providing the hospitality service;
monitoring, in real-time, a location of each respective
computing device of the plurality of computing
devices based on location data received from a
location monitor of the respective computing device;
determining whether to subject a respective point-of-sale (POS) computer,
electronic reservation book (ERB) computer, and
payment gateway computer to either (i) a default
set of guidelines, or (ii) an alternative set of guidelines associated
with a geofenced area and/or RF module, based on the location of
the respective computing device relative to the
geofenced area and/or RF module;
for each subjected point-of-sale (POS) computer,
electronic reservation book (ERB) computer, and
payment gateway computer of the plurality of
point-of-sale (POS) computer(s), electronic reservation book (ERB)
computer(s), and payment gateway computer(s) that is subject to
the alternative set of guidelines, input an
identifier of the subjected point-of-sale (POS) computer,
electronic reservation book (ERB) computer, and
payment gateway computer into a state, the identifier indicating
an operational state to subject the point-of-sale (POS) computer,
electronic reservation book (ERB) computer, and
payment gateway from a plurality of states for the geofenced area/or RF module,
receiving, over the one or more networks, indication of a location-based event
from a computing device of a first user(s), the location-based event
indicating a user device has entered, exited, or performed some action
within the geofenced and/or RF module area;
arranging the hospitality service for the first user(s)
by (i) selecting the point-of-sale (POS) computer,
electronic reservation book (ERB) computer, and
payment gateway computer from one of the plurality of states
and (ii) communicating, over the one or more networks, the set of instructions associated with the state to the selected point-of-sale (POS) computer,
electronic reservation book (ERB) computer, and payment gateway computer;
receiving, over the one or more networks, a second
hospitality request from a computing device of a
second requesting user(s), the second hospitality request
indicating a request external to the
geofenced area and/or RF module; and
arranging the hospitality service for the second requesting
user(s) by (i) selecting the point-of-sale (POS) computer(s),
electronic reservation book (ERB) computer(s), and payment gateway computer(s) based at least in part on a proximity of the service provider geolocation of the second hospitality request, and (ii) communicating, over the one or more networks, the set of instructions associated with the state to the selected point-of-sale (POS) computer, electronic reservation book (ERB) computer, and payment gateway computer

11. The method of claim 10, wherein the executed set of instructions
further cause the computing system to:
for each respective user, generate a record indicating a number of instances in which the respective user(s) enter and/or exit the service provider geolocation to receive the hospitality service.

12. The method of claim 10, wherein the executed set of instructions further cause the computing system to:
for each respective user, generate a record indicating a duration of time a user(s) has remained at a seating location within the service provider geolocation.

13. The method of claim 10, wherein the executed set of instructions further cause the computing
system to:
determine the alternative set of guidelines by accessing a database and/or digital ledger (e.g., blockchain database) that stores information
corresponding to the geofenced area and/or RF module, the information including an identifier of a point-of-sale (POS) computer(s), electronic reservation book (ERB) computer(s), and payment gateway computer(s) associated with the geofenced area and/or RF module.

14. The method of claim 10, wherein the executed set of instructions further cause the computing system to:
monitor, in real time, an operational state of a user application executing on each of the plurality of computing devices of each respective user, the operational state indicating at least one of (i) whether the respective user has selected a service provider and performed one or more biometric authentication method(s) to receive the hospitality service, or (ii) whether the respective user has failed to perform a successful biometric authentication method(s) to receive the hospitality service.

15. The method of claim 10, wherein the executed set of instructions (in the alternative set of guidelines) further cause the computing system to:
monitor, in real time, an operational state of a point-of-sale (POS) computer(s), electronic reservation book (ERB) computer(s), and payment gateway computer(s), the operational state indicating at least one of (i) an entry state, e.g., after the respective user has entered a service provider geolocation associated with the geofence and/or RF module, based on the location data provided by the user device, request the point-of-sale (POS) computer to generate and/or display a touch-sensitive moveable (e.g., drag and drop) open check in a region on the GUI screen display associated with corresponding user information (e.g., a user identifier (ID) associated with the user, a digital ledger identifier (ID) associated with the user, a name, a photograph, a phone number, e-mail address, a device (ID) associated with user device, an application (ID) associated with the user application), request the point-of-sale (POS) computer to generate and display an illuminable touch-sensitive transfer check button configured as a selectable GUI widget in a region on the GUI screen display, request the electronic reservation book (ERB) computer to generate and/or display a moveable (e.g., drag and drop) reservation in a region on the GUI screen display associated with corresponding user information, request the electronic reservation book (ERB) computer to generate and/or display a moveable (e.g., drag and drop) wait list entry in a region on the GUI screen display associated with corresponding user information, (ii) an order request state, e.g., after the respective user has indicated via user input on the user application a request to start an order, request the point-of-sale (POS) computer to generate and display an identifier corresponding to an identifier associated with the moveable open check corresponding to the user in a region on the GUI screen display with a distinctive illumination treatment (e.g., highlight, flash, colored, etc.), (iii) a pending item state, e.g., after the respective user has indicated via user input on the user application one or more menu line item(s) (e.g., food, beverage, or other products or services) and/or after the respective administrative user has indicated via admin user input in the point-of-sale (POS) computer one or more menu line item(s) (e.g., food, beverage, or other products or services), request the point-of-sale (POS) computer to generate and display one or more menu line item(s) (e.g., food and beverage or other products or services) as moveable widgets (e.g., drag and drop) in a region on the moveable open check corresponding to the respective user that when selected activate one or more modifiers, (iv) an identified seating state, e.g., after the respective administrative user has moved a moveable reservation and/or wait list entry in the electronic reservation book (ERB) computer to a seating location on the GUI screen display and/or entered a location identifier (e.g., seat, table number) in the point-of-sale (POS) computer, request the point-of-sale (POS) computer to generate and display the corresponding location identifier (e.g., seat, table number) in a region on the moveable open check and/or automatically transfer the moveable open check to the seating location associated with the corresponding location identifier, (v) a payment authorization state, e.g., after the respective user has indicated via user input on the user application one or more menu line item(s) (e.g., food, beverage, or other products or services) and/or after the respective administrative user has indicated via admin user input in the point-of-sale (POS) computer one or more menu line item(s) (e.g., food, beverage, or other products or services) totaling a pre-determined authorization limit, request the payment gateway computer to authorize but not yet capture a payment amount, (vi) a check request state, e.g., after the respective user has indicated via user input on the user application a request for a check, request the point-of-sale (POS) computer to generate and display a notification and/or alert indicating a request to pay a check in a region on the moveable open check and/or request the point-of-sale (POS) computer to generate and display a touch-sensitive send payment button in a region on the moveable open check, (vii) a payment capture state, e.g., after the respective user has selected a pay button via user input on the user application request the payment gateway computer to capture the previously authorized amount and request to authorize and capture the difference between the final total ticket amount (e.g., tax, gratuity, and any other current charges) and previously authorized amount and/or request to authorize and capture the final total ticket amount (e.g., tax, gratuity, and any other current charges) upon detecting no prior authorization, (viii) an unsuccessful payment capture state, e.g., in response to an unsuccessful final total ticket amount payment capture in the payment gateway computer, request the point-of-sale (POS) computer to generate and display a notification and/or alert in a region on the moveable open check indicating an unsuccessful payment capture and/or request for an alternate or backup payment source (e.g., another credit card on file), (ix) a successful payment capture state, e.g., in response to a successful final total ticket amount payment capture in the payment gateway computer, request the point-of-sale (POS) computer to generate and display a notification and/or alert in a region on the moveable open check indicating a provisional electronic receipt, request the electronic reservation book (ERB) computer to generate and display a confirmed payment message for the seating location corresponding to the provisional electronic receipt in a region on the GUI screen display, (x) an exit state, e.g., after the respective user has traveled a fixed distance and/or exceeded a given time duration outside the virtual perimeter of the service provider geolocation and/or RF module with a remaining balance on a moveable open check, request the payment gateway computer to capture the previously authorized amount and request to authorize and capture the difference between the final total ticket amount (e.g., tax, gratuity, and any other current charges) and previously authorized amount and/or request to authorize and capture the final total ticket amount (e.g., tax, gratuity, and any other current charges) upon detecting no prior authorization, request the point-of-sale (POS) computer to generate and display a notification and/or alert in a region on the moveable open check indicating a balance due message, request the point-of-sale (POS) computer to generate and display a capture payment button in a region on the moveable open check, request the point-of-sale (POS) computer to generate and display a notification and/or alert in a region on the moveable open check indicating an unsuccessful payment capture and/or request for an alternate or backup payment source (e.g., another credit card on file) in response to an unsuccessful payment capture in the payment network gateway computer, request the point-of-sale (POS) computer to generate and display a notification and/or alert in a region on the moveable open check indicating a provisional electronic receipt in response to a successful payment capture, request the point-of-sale (POS) computer to automatically close a moveable open check associated with a provisional electronic receipt, request the electronic reservation book (ERB) computer to generate and display a confirmed payment message for the seating location corresponding to the provisional electronic receipt in a region on the GUI screen display in response to a successful payment capture, request the electronic reservation book (ERB) computer to automatically remove a reservation and/or waitlist entry associated with user information.

16. The method of claim 2, wherein the geofenced area and/or
RF module corresponds to hospitality services, which can be selected from a restaurant, hotel, shopping mall, cruise ship, airline, theatre, gaming venue, stadiums, resort, theme park, and concert venue.

17. The method of claim 2, wherein the geofenced area and/or
RF module corresponds to a point-of-sale (POS) computer,
electronic reservation book (ERB) computer, and
payment gateway computer.

18. A contactless payment system for hospitality services for a hospitality venue, comprising:
a computing system comprising one or more processors for executing computer-readable instructions;
one or more databases and/or digital ledgers (e.g., blockchain database) for storing the computer-readable instructions,
a plurality of hospitality computing devices;
one or more networks interconnecting the computing system and the plurality of hospitality computing devices by one or more internet and/or local connections;
a user computing device in data communication with the computing system:
a geofence for defining a geofenced area and/or an RF module located for defining a proximity,
wherein the computing system determines whether a user computing device is within the geofenced area and/or in proximity to an RF module.

19. A method for contactless payment utilizing the system of claim 18.
